(19) United States
(12) Patent Application Publication
(10) Pub. No.: US 2017/0039200 A1
(43) Pub. Date: Feb. 9, 2017

(54) EVALUATING USER EXPERIENCE

(71) Applicant: HEWLETT PACKARD ENTERPRISE DEVELOPMENT LP, Houston, TX (US)

(72) Inventors: Ola Galkin, Yehud (IL); Guy Offer, Yehud (IL); Haim Shuvali, Yehud (IL); Amichai Nitsan, Yehud (IL)

(73) Assignee: HEWLETT PACKARD ENTERPRISE DEVELOPMENT LP, Houston, TX (US)

(21) Appl. No.: 15/303,254

(22) PCT Filed: Jun. 4, 2014
(86) PCT No.: PCT/US2014/040903

§ 371 Date: Oct. 11, 2016

(51) Int. Cl. G06F 17/30; G06F 11/07

(52) U.S. Cl. CPC G06F 17/3053; G06F 17/30867; G06F 11/0766

(57) ABSTRACT

Evaluating user experience for an application includes collecting, for each of a plurality of user sessions, a list of user event data items experienced from a perspective of a user device during that user session. For each user session, a session score is discerned based on an analysis of that user session's list of user event data items. Each session score is associated with a corresponding one of the plurality of users. For each of a plurality of successive time periods, user scores are discerned for each of the plurality of users. Each user score is discerned as a function of all session scores associated with that user where those session scores are for user sessions occurring during that time period. For each of the successive time periods, a period score is discerned as a function of the user scores discerned for that time period. The time period score discerned for a selected one of the successive time periods can be reported.

### BACKGROUND

Many services are delivered to consumers via software applications. These applications may be composite in that several software components work in conjunction to realize the service. Those components may be distributed across various physical and virtual devices. A client side user interface component may be presented by a smartphone, laptop or other user computing device. Through that user interface component, a user can initiate a series of actions carried out by the user computing device and by server side components in an attempt to achieve a desired goal. A user's experience with an application can be effected by numerous factors such as usability, stability, performance and availability of its various components.

### DRAWINGS

FIG. 1 is a block diagram depicting an example environment in which various embodiments may be implemented.

FIG. 2 is a block diagram depicting an example of a system for identifying a common user flow.

FIG. 3 is a block diagram depicting a memory resource and a processing resource according to an example.

FIG. 4 is a flow diagram depicting actions taken to implement an example.

### DETAILED DESCRIPTION

### Introduction

User experience, commonly abbreviated as UX, involves a person's behaviors, attitudes, and emotions about using a particular software product. While subjective in nature, user experience for a software product can, as explained in more detail below, be quantified by evaluating differences to between events expected and those actually experienced when using the application. Events can include application faults and response times for user actions. Improving user experience of an application can lead to improved adoption of the application, increased retention of application users, and increased productivity for those users.

Various embodiments described below can be used to quantify and evaluate user experience of an application. For each user session of a selected application, user event data items are collected. User event data items are discrete pieces of information that are reflective of events experienced by a user during a given user session. An event is an application event experienced from a perspective of a user device and thus from a perspective of a user. Events can include responses to user actions and application faults. Responses include application launches and other user interface updates performed in response to user interaction with the application's user interface. Such responses can be measured by response times. From a user's perspective, a response time for a launch (launch time) is a duration measured from when a user interacted with a user device to initiate the application until the application is in a state allowing user interaction. A response time for other user interactions is measured from when a user interacts with the application and when a user interface is updated to provide a response. Application faults can include fatal application crashes and non-fatal errors.

Based on an analysis of the collected user event data items, a session score is calculated for each user session. User session may begin when a user launches the application and end when that application is closed. An application may be determined to be closed when it moved to the background of the user device for more than a threshold period. In such cases the session stays active even when a user temporarily switches away from the application. A user session may be considered to be a fixed or variable period of time of use of that application. A user session, for example, may be deemed to be a five minute period of time such that twenty minutes of continued use would be deemed to cover four user sessions. Each session score is associated with one of a plurality of users of that application. Each user session falls within a time period. A time period, for example, may be a day. User scores are derived for each user. For a given time period, each user score is derived based upon a user's associated session scores for sessions occurring within that time period. For example, each user score may be a function of an average of such session scores. A time period score is derived based upon user scores for a selected time period. An experience score is derived based on a selected number of time period scores. The scores can be reported for use in objectively measuring user experience for the application.

### Components

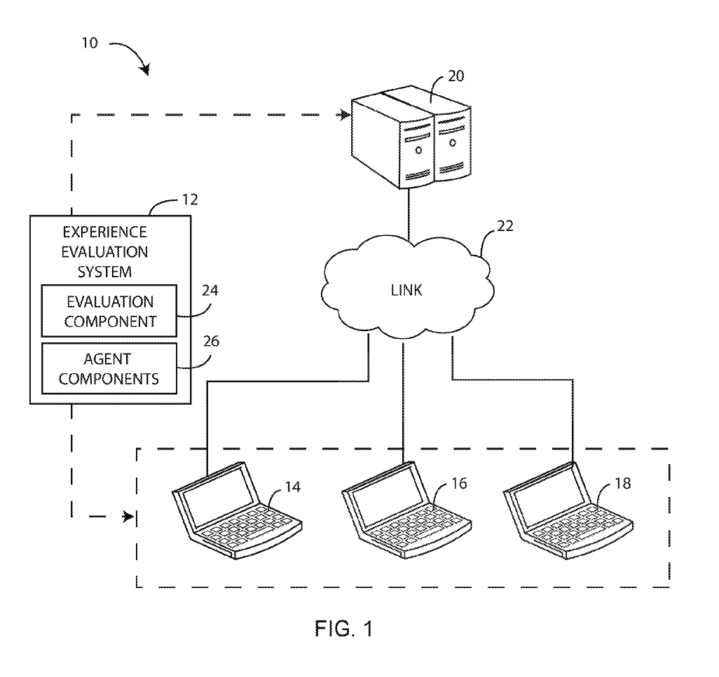

FIG. 1 depicts an example environment 10 in which embodiments may be implemented as experience evaluation system 12. Environment 10 is shown to include user devices 14-18 and server device 20. Each user device 14-18 represents a computing device configured to communicate requests to and receive responses from server device 20. Server device 20 represents a computing device capable of receiving and responding to requests from client devices 14-18. While depicted as laptop computers, user devices 14-18 can include any type of computing device providing a user interface through which a user can interact with a software application. While server device 20 is depicted as a single computing device, server device 20 may include any number of integrated or distributed computing devices serving one or more software applications for consumption by user devices 14-18.

Components 14-20 are interconnected via link 22. Link 22 represents generally any infrastructure or combination of infrastructures configured to enable electronic communication between components 14-20. For example, link 22 may represent the internet, one or more intranets, and any intermediate routers, switches, and other interfaces.

Server device 20 serves an application for consumption by user devices 14-20. Users interact with that application via a user interfaces of user devices 14-20. Through the user interfaces, those users can take a number of actions including starting or opening a user session and interacting with user interface controls. Application events occur as a result of those user actions. Events can include application launch, responses or results of such actions such user interface updates or changes in response to a selection of a control. Events can also include application faults such as errors and crashes.

Experience evaluation system 12, discussed in more detail below, represents a combination of hardware and programming configured to quantify a user experience based on application events occurring during user sessions with respect to user devices 14-18. In doing so, system 12, collects user event data items from user devices 14-18. Each collected item may be associated with a corresponding user session of an application served by server device 20. Each such user session can be associated with application environment characteristics such as a particular user, a particular user device, a user device location, an operating system, and an application version.

User event data items can include application fault data items and response data items. Each application fault data item represents an application fault such as an error or crash that occurred during a user session. A fault might be fatal such as an application crash or non-fatal such as a recoverable error. Each response data item represents a response to a user action and indicates a corresponding response time. The user actions may, for example, include application launches and actions taken with respect to the application's user interface. The response time is then a duration measured from when the user took a corresponding action and when the user experienced an expected response from the application. An expected response may take the form of a user interface update indicating an error or successful response to the user action. In an example, a user action can include a user interaction with a link, a command button, a radio button, a text box, or any other user interface object.

System 12 can then derive a number of scores quantifying user experience. The derived scores can include a session scores, user scores, time period scores and an experience score. A session score is derived as a function of the user event data items collected for a given user session. A user score is derived as a function of a number of session scores derived for a given time period for a given user. An experience score is derived from a selected number of time period scores. System 12 reports selected scores. Reporting can include communicating a user experience score, session scores and event scores an electronic message. Reporting can include posting the scores to a repository where they can be processed to assemble a human readable report such as a dashboard.

System 12 may be integrated entirely in server device 20 or distributed across server devices not shown. System 12 may be distributed across server device 20 and client devices 14-18. For example, system 26 may include an agent components 26 operating on client devices 14-18 (or other devices not shown) and an evaluation component 28 operating on server device 20 (or another device not shown). In this distributed model, the agent components 26 are responsible for reporting user event data items to evaluation component 24 which in turn is responsible for processing those data items to session, user, time period, and evaluation scores.

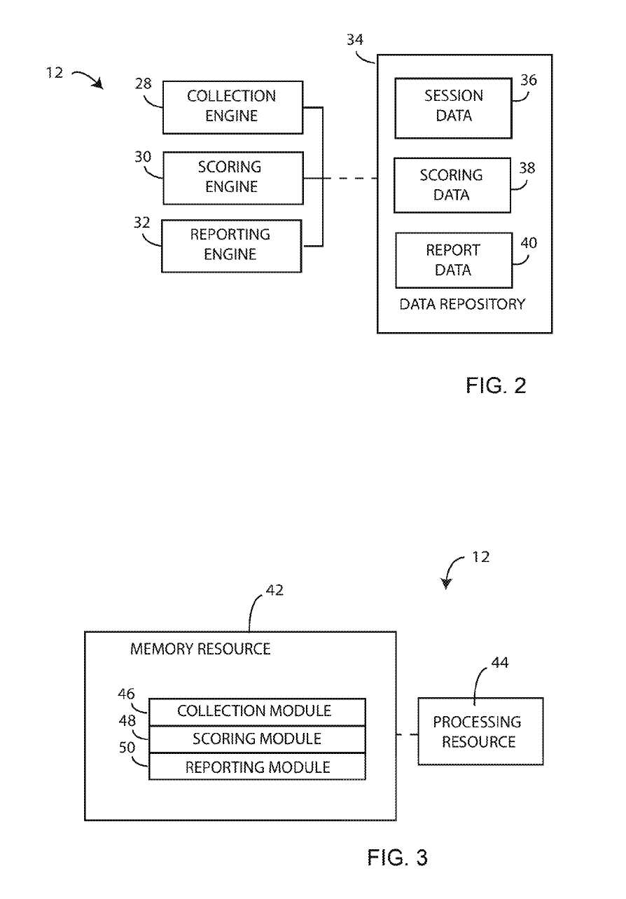

FIGS. 2-3 depict examples of physical and logical components for implementing various embodiments. In FIG. 2 various components are identified as engines 28-32. In describing engines 28-32, focus is on each engine's designated function. However, the term engine, as used herein, refers to a combination of hardware and programming configured to perform a designated function. As is illustrated later with respect to FIG. 3, the hardware of each engine, for example, may include one or both of a processing resource and a memory resource, while the programing is code stored on that memory resource and executable by the processing resource to perform the designated function.

FIG. 2 is a block diagram depicting components of experience evaluation system 12. In this example, system 12 includes collection engine 28, scoring engine 30, and reporting engine 32. In performing their respective functions, engines 28-32 may access data repository 34. Repository 34 represents generally any memory accessible to system 12 that can be used to store and retrieve data.

Collection engine 28 is configured to collect user event data items for each of a plurality of user sessions. Each user session is associated with one of a plurality of users, and each user event data item is reflective of an application event from a user device perspective. Looking back at FIG. 1, collection engine 28 may be implemented by evaluation component 24 whereby by it collects user event data items reported from agent components 26 operating on user devices 14-18. In another example, engine 28 may be implemented by agent components 26 and evaluation components 24. In this example, agent components 26 operating on user devices 14-18 detect the initiation of user sessions and each of a series of additional user event data items experienced during those user sessions. The agent components 26 report those user event data items to the server component 24. The reporting may be completed as batches at the end of each user session or as a stream occurring during those user sessions. The reporting can include other items such as a user session duration and application environment characteristics such as user identifier, device identifier, device location, operating system, and application version.

Collection engine 28 may deem a user session to start when the application is launched and to be ended when the application is closed or moved to the background of the user device for more than a threshold period. In such cases the session stays active even when a user temporarily switches away from the application. Collection engine 28 may deem a user session to be a fixed or variable period of time of use of that application. A user session, for example, may be deemed to be a five minute period of time such that twenty minutes of continued use would be deemed to cover four user sessions. A fixed duration can help normalize results when comparing user experiences between user sessions.

Scoring engine 30 is configured to derive one or more scores based upon the user event data items collected for each user session. Derived scores include session scores, user scores, time period scores, and experience scores. Scoring engine 30 derives each session score based upon an analysis of the user event data items collected for a corresponding user session. Each session score is associated with a given user. Scoring engine 30 derives each user score based upon a user's associated session scores derived for sessions occurring during a predetermined time period. Over time, scoring engine 30 is responsible for deriving user scores for successive time periods. Each user score is based upon session scores associated with that user for sessions occurring during each successive time period. Scoring engine 30 derives experience scores based upon a selected number of successive time period scores.

Each user score, for example, may represent an average of all of the user's associated session scores for sessions occurring during a corresponding time period. Each time period score may represent an average of user scores for a corresponding time period. The number of session scores within a time period may differ from user to user. Thus, each user score has the same impact on a corresponding time period score regardless of the number of session scores used to derive that user score.

Assume a time period of one day, each user will have the same impact on the time period score. In comparison, a single user's interactions with the application over multiple time periods (days in this example) will impact the experience score more than a single user who interacts with the application in fewer time periods. In this fashion, each time period score is predictive of a future user's experience in subsequent time period. An experience score is reflective of overall user experience of that application for a longer duration.

The user event data items collected by collection engine 28 may include response time data items and application fault data items. Each response time data item includes data indicative of an application response time with respect to a user interface action. The data may include the response time itself or data indicating whether the response time fell within or exceeded a threshold duration. Each application fault data item may include data identifying the occurrence of an error or crash. An application fault data item may also include more specific details of a particular error or crash.

In this example, scoring engine 30 is configured to analyze the response and application fault data items of each user session to derive a corresponding session score. Scoring engine 30 may derive each session score as a function of a count or a percentage of collected response time data items indicating a response time within a threshold duration. Scoring engine 30 may derive a session score based on a count of application faults occurring during a corresponding session. In one example, scoring engine 30 may derive, for each user session, a preliminary session score based on the application fault data collected for that session. For example, scoring engine 30 may with a base score of 100 and subtract a penalty calculated based on a count of application faults experienced during a given session to arrive at the intermediate score. Scoring engine 30 may then derive the session score as a function of the intermediate score and a count or percentage of the collected response data items that indicate response times within a threshold duration. For example, the session score may be derived as a product of the intermediate score and that percentage.

Collected user event data items can be stored as user session data 36. User session data 36 may include data items and scores for each of a plurality of user sessions for a given application. For a given user session, the data may be represented by a time ordered sequence of user event data items. User session data 38 can also include additional information that can identify any of a user session duration, user, a user device, a device location, an operating system, and an application version associated with each given user session. The data may also identify a duration of each user session. Value data 38 represents data for use by scoring engine 30 to derive session scores. Such may include threshold response times and any weighting factors. For example, response times for an application launch may be weighted to affect a session score more than a response time for a different user interface interaction. In other words, a slow launch time may affect a session score more than a slow response to the selection of a submit button.

Reporting engine 32 is configured to report scores derived by scoring engine 32. Scoring engine 30 may store those scores as report data 40 for use by reporting engine 32. Reporting can include communicating selected session scores, user scores, time period scores, and experience scores in electronic messages. Reporting can include posting the scores to a repository where they can be processed to electronically assemble a human readable report such as a dashboard.

As noted, user event data items for each user session may be collected along with application environment indicators. These indicators can include two or more different user devices, two or more different user locations, two or more different operating systems, and two or more different versions of the application. In this example, reporting engine 32 is then configured to report the session, user, time period, and experience scores to provide a comparison between two or more selected application environments. Such could include a comparison of scores between two application versions, between two device locations, between two operating systems, or between two user types.

With reference back to FIG. 1, collection engine 28 can be implemented in a number of fashions. Collection engine 28 may be implemented as a client side agent component 26 that reports the user event data items, a server side evaluation component 24 that receives the user event data items, or a combination of the two. Scoring and reporting engines 30 and 32 may be implemented in part as a client side agent component 26 and as a server side evaluation component 24. Scoring and reporting engines 30 and 32 may be implemented entirely as a server side evaluation component 24.

In the foregoing discussion, engines 28-32 were described as combinations of hardware and programming. Engines 38-32 may be implemented in a number of fashions. Looking at FIG. 3, the programming may be processor executable instructions stored on tangible memory resource 42 and the hardware may include processing resource 44 for executing those instructions. Thus memory resource 42 can be said to store program instructions or code that when executed by processing resource 44 implements system 12 of FIG. 2.

Memory resource 42 represents generally any number of memory components capable of storing instructions that can be executed by processing resource 44. Memory resource 42 is non-transitory in the sense that it does not encompass a transitory signal but instead is made up of more or more memory components configured to store the relevant instructions. Memory resource 42 may be implemented in a single device or distributed across devices. Likewise, processing resource 44 represents any number of processors capable of executing instructions stored by memory resource 42. Processing resource 44 may be integrated in a single device or distributed across devices. Further, memory resource 42 may be fully or partially integrated in the same device as processing resource 44, or it may be separate but accessible to that device and processing resource 44.

In one example, the program instructions can be part of an installation package that when installed can be executed by processing resource 44 to implement system 12. In this case, memory resource 42 may be a portable medium such as a CD, DVD, or flash drive or a memory maintained by a server from which the installation package can be downloaded and installed. In another example, the program instructions may be part of an application or applications already installed. Here, memory resource 42 can include integrated memory such as a hard drive, solid state drive, or the like.

In FIG. 3, the executable program instructions stored in memory resource 42 are depicted as collection, scoring, and reporting modules 46-50 respectively. Modules 46-50 represent program instructions that, when executed, cause processing resource 44 to implement engines 28-32 respectively.

### Operation

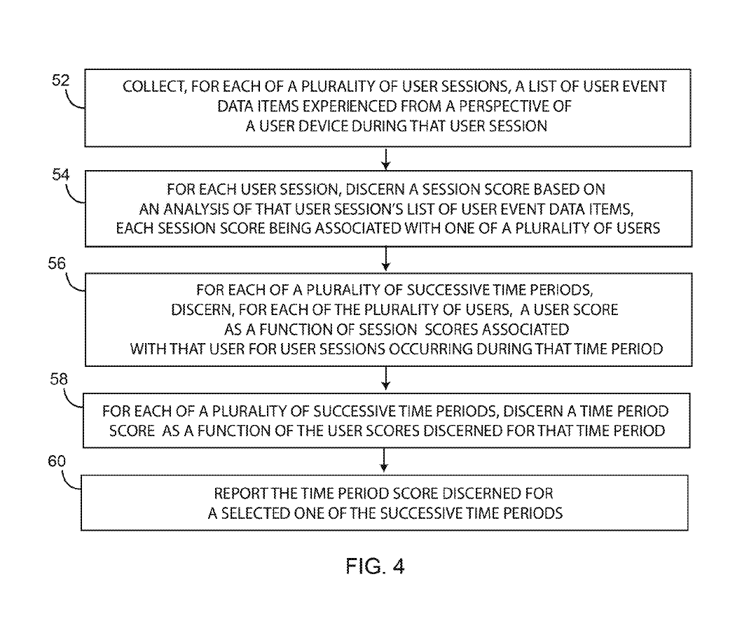

FIG. 4 is a flow diagram of actions taken to implement a method for evaluating user experience for an application. In discussing FIG. 4, reference may be made to components depicted in FIGS. 1-3. Such reference is made to provide contextual examples and not to limit the manner in which the method depicted by FIG. 4 may be implemented.

A list of user event data items is collected for each of a plurality of user sessions (block 52). The data items collected for a given user session are data items experienced from a perspective of a user device during that user session. For each user session, a session score is discerned based on an analysis of that user session's list of user event data items (block 54). Each session score is associated with one of a plurality of users. For each of a plurality of successive time periods, a user score is discerned for each of the plurality of users (block 56). Each user score is derived as a function of session scores associated with that user for sessions occurring during that time period. For each of the plurality of successive time periods, a time period score is discerned as a function of the user scores discerned for that time period (block 58). Step 58 can include discerning, for a selected set of two or more of the successive time periods, an experience score as a function of the time period scores discerned for that set of time periods. Where for example, a time period is a day, the selected set may reflect a week, month, or a year. The time period scores discerned for a selected number of the successive time periods are reported (block 60). Block 60 can also include reporting a discerned experience score.

Each user score may, in block 58, be discerned based on an average of the sessions scores assigned to a given user for sessions occurring during a given time period. The time period score, discerned in block 56 may be discerned as an average of user scores derived for that time period. In doing so, each user score has an equal impact on the discerned time period score regardless of the number of session scores from which that user score was discerned.

Each list of user event data items collected in block 52 can include response data items each indicative of a response time from a user device perspective. Discerning each session score in block 54 can then include discerning a session score that is a function of a count of the user session's response time data items that are indicative of response times that are less than a threshold duration.

Each list of user event data items collected in block 52 can include fault data items each indicative of an application fault experienced during a corresponding user session and response data items each indicative of a response time experienced during a corresponding user session. Discerning each session score in block 54 can then include discerning a session score that is a function of a count of the user session's fault data items and a count of the user session's response data items that are indicative of response times that are less than a threshold duration. Discerning each session score in block 54 may include deriving a fault value as a function of the user session's count of fault data items and then deriving the session score as a function of the fault value and the count of the user session's response data items that are indicative of response times that are less than the threshold duration. An example can include subtracting the fault value from an initial score and then adjusting that result based on a percentage of the response data items that are inactive of good response times. Here, good response times are those that fall within a threshold duration.

Referring back to FIG. 2, collection engine 28 may be responsible for implementing block 52. Scoring engine 30 may be responsible for implementing blocks 54-58, and reporting engine 32 may be responsible for implementing block 60.

### Conclusion

FIGS. 1-3 aid in depicting the architecture, functionality, and operation of various embodiments. In particular, FIGS. 1-3 depict various physical and logical components. Various components are defined at least in part as programs or programming. Each such component, portion thereof, or various combinations thereof may represent in whole or in part a module, segment, or portion of code that comprises one or more executable instructions to implement any specified logical function(s). Each component or various combinations thereof may represent a circuit or a number of interconnected circuits to implement the specified logical function(s).

Embodiments can be realized in any memory resource for use by or in connection with processing resource. A “processing resource” is an instruction execution system such as a computer/processor based system or an ASIC (Application Specific Integrated Circuit) or other system that can fetch or obtain instructions and data from computer-readable media and execute the instructions contained therein. A “memory resource” is any non-transitory storage media that can contain, store, or maintain programs and data for use by or in connection with the instruction execution system. The term “non-transitory is used only to clarify that the term media, as used herein, does not encompass a signal. Thus, the memory resource can comprise any one of many physical media such as, for example, electronic, magnetic, optical, electromagnetic, or semiconductor media. More specific examples of suitable computer-readable media include, but are not limited to, hard drives, solid state drives, random access memory (RAM), read-only memory (ROM), erasable programmable read-only memory, flash drives, and portable compact discs.

Although the flow diagram of FIG. 4 shows a specific order of execution, the order of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details and embodiments may be made without departing from the spirit and scope of the invention that is defined in the following claims.

What is claimed is:

1. A method for evaluating user experience for an application, comprising:
collecting, for each of a plurality of user sessions, a list of user event data items experienced from a perspective of a user device during that user session;
for each user session, discerning a session score based on an analysis of that user session's list of user event data items, each session score being associated with one of a plurality of users;
for each of a plurality of successive time periods:
discerning, for each of the plurality of users, a user score as a function of session scores associated with that user for user sessions occurring during that time period; and
discerning a time period score as a function of the user scores discerned for that time period; and
reporting the time period score discerned for a selected one of the successive time periods.

2. The method of claim 1, wherein discerning a time period score as a function of the user scores comprises discerning a time period score that is a function of an average of the user scores discerned for that time period such that each user score has an equal impact on the discerned time period score regardless of the number of session scores from which that user score was discerned.

3. The method of claim 1, comprising discerning, for a selected set of two or more of the successive time periods, an experience score as a function of the time period scores discerned for the selected set.

4. The method of claim 1, wherein:
each collected list of user event data items includes response data items each indicative of a response time from a user device perspective; and
discerning a session score comprises, for each user session, discerning a session score that is a function of a count of the user session's response time data items that are indicative of response times that are less than a threshold duration.

5. The method of claim 1, wherein:
each collected list of user event data items includes fault data items each indicative of an application fault experienced during a corresponding user session and response data items each indicative of a response time experienced during a corresponding user session; and
discerning a session score comprises, for each user session, discerning a session score that is a function of a count of the user session's fault data items and a count of the user session's response data items that are indicative of response times that are less than a threshold duration.

6. The method of claim 5, wherein discerning a session score comprises, for each user session:
deriving a fault value as a function of the user session's count of fault data items; and
deriving the session score as a function of the fault value and the count of the user session's response data items that are indicative of response times that are less than the threshold duration.

7. A memory resource storing instructions that when executed cause a processing resource to implement a system for evaluating user experience, the instructions comprising:
a collection module that when executed causes the processing resource to collect user event data items experienced during each of a plurality of user sessions, the collected data items including data indicative of response times and application faults, and each user session being associated with one of a plurality of users;
a scoring module that when executed causes the processing resource derive a session score for each of the plurality of user sessions, a user score for each of the plurality of users, and a time period score, wherein:
each session score is associated with one of the plurality of users and is derived based on the data indicative of response times and application faults collected for that user session;
each user score is associated with one of the plurality of users and is derived based on those of the derived user sessions scores for user sessions occurring within a time period and associated with that user; and
the time period score being is based on the derived user scores; and
a reporting module that when executed causes the processing resource to report derived scores.

8. The memory resource of claim 6, wherein the scoring module, when executed, causes the processing resource to:
for each of a plurality of successive time periods, derive, for each of the plurality of users, a user score, wherein each user score is derived as a function of an average of the derived session scores for that time period that are associated with that user;
derive an experience score as a function of an average of a selected plurality of the derived time period scores.

9. The memory resource of claim 6, wherein the scoring engine, when executed, causes the processing resource to:
analyze, for each user session, the response time data collected for that user session to identify a count of application faults and percentage of response times for that user session that fall within a threshold duration; and
derive, for each user session, a session score as a function of the count and the percentage identified for that user session.

10. The memory resource of claim 9, wherein the scoring engine, when executed, causes the processing resource to derive, for each user session, a session score by:
discerning a preliminary session score based on the count; and
discerning the session score as a function of the preliminary score and the percentage identified for that user session.

11. A system for evaluating user efficiency for an application, the system comprising a collection engine, and a scoring engine, wherein:
the collection engine is configured to collect user event data items for each of a plurality of user sessions, wherein each user session is associated with one of a plurality of users and each user event data item is reflective of an application event from a user device perspective;
the scoring engine is configured to generate a session score for each of the plurality of user sessions, a user score for each of the plurality of users, and a time period score, wherein:
each session score is associated with one of the plurality of users and is derived based upon an analysis of the user event data items collected for a corresponding one of the plurality of user sessions;
each user score is derived based upon the derived session scores that are associated for that user for a specified time period; and
the time period score is based upon an average of the derived user scores for the time period.

12. The system of claim 11 wherein the scoring engine is configured to:
for each of a plurality of successive time periods, derive, for each of the plurality of users, user scores, wherein each user score is derived as a function of an average of the derived session scores for that time period that are associated with that user; and
derive an experience score as a function of an average of a selected plurality of the derived time period scores.

13. The system of claim 12: comprising a reporting engine configured to report selected ones of the derived experience score, user scores, and time period scores.

14. The system of claim 11, wherein:
the user event data items collected for each user session include data items indicative of a plurality of response times; and
the scoring engine is configured to derive each session score based on the data items as a function of a count of the user session's data items that are indicative of response times that exceed a threshold duration.

15. The system of claim 11, wherein.
the user event data items collected for each user session include data items indicative of a plurality of response times and a number of application faults; and
the scoring engine is configured to derive each session score based on the data items as a function of a count of the user session's application faults and a percentage of the user session's data items that are indicative of response times that fall within a threshold duration.
